(19) United States
(12) Patent Application Publication
(10) Pub. No.: US 2008/0022052 A1
(43) Pub. Date: Jan. 24, 2008

(54) Bus Coupled Multiprocessor

(75) Inventor: Mamoru Sakugawa, Tokyo (JP)

Correspondence Address: BUCHANAN, INGERSOLL & ROONEY PC, POST OFFICE BOX 1404, ALEXANDRIA, VA, 22313-1404, US

(73) Assignee: Renesas Technology Corp., Tokyo (JP)

(21) Appl. No.: 11/775,952

(22) Filed: Jul. 11, 2007

(30) Foreign Application Priority Data
Jul. 18, 2006 (JP) 2006-195399

(51) Int. Cl. G06F 12/08

(52) U.S. Cl. 711/146; 711/E12.032

(57) ABSTRACT

There is provided a bus coupled multiprocessor capable of reducing the number of snooping processes of each of a plurality of processors (CPU) constituting the multiprocessor, whereby the performance of the CPU is improved and its power consumption is reduced. According to the present invention, each of the CPUs includes a register for storing a bit string containing a first bit indicating whether the snooping process is performed or not when each of the CPUs is in a predetermined operation mode, and a comparing unit for comparing the first bit stored in the register with mode information indicating the kind of the operation mode outputted when the predetermined CPU accesses the bus. The snooping process is selectively performed based on the result of comparison in the comparing unit.

### BACKGROUND OF THE INVENTION

1. Field of the Invention

The present invention relates to a bus coupled multiprocessor in which a plurality of processors each having a cache memory and having a snooping function for the cache memory are connected through the same bus.

2. Description of the Background Art

In the bus coupled multiprocessor, every time another CPU accesses the bus, each CPU confirms (observes) whether there is data having the same contents in its own cache memory to keep coherency of the cache memory. Thus, to observe the bus to maintain the coherency of the cache memory contained in the CPU is called a bus snooping process (or simply snooping process).

In addition, in the bus coupled multiprocessor, in order to arbitrate the access of the CPU fairly, a bus interface in each CPU conducts arbitration based on identification information (CPUID) outputted from another CPU in round-robin fashion. Here, the CPUID means identification information unique to each CPU.

In addition, the above-described bus coupled multiprocessor is a well-known technology and described in many text books. Also, the bus coupled multiprocessor is manufactured by many companies. Furthermore, the following documents disclose the multiprocessor as background art documents:

Japanese Patent Application Laid-Open No. 2-297656;

Japanese Patent Application Laid-Open No. 2-238534;

Japanese Patent Application Laid-Open No. 9-6730;

Japanese Patent Application Laid-Open No. 2-77870;

Japanese Patent Application Laid-Open No. 2005-141606;

Japanese Patent Application Laid-Open No. 3-241453;

Japanese Patent Application Laid-Open No. 4-278660; and

Japanese Patent Application Laid-Open No. 8-55089.

However, according to the snooping process, every time another CPU accesses the bus, it is to be confirmed whether there is data having the same contents in its own cache memory or not, so that as the number of the CPUs connected to the same bus is increased, the number of snooping processes is also increased. Thus, as the number of snooping processes is increased in proportion to the increase in the number of the CPU, the number of accesses to the cache memory is also increased.

Thus, the increase in the number of accesses to the cache memory causes the increase in power consumption in the circuit as a whole. In addition, since the number of accesses to the cache memory for the normal processing operation is reduced due to the accesses to the cache memory by the snooping process, as the number of CPUs connected to the same bus is increased, the processing capability of the CPU is lowered.

Due to the above-described problem (that is, in view of the CPU processing capability and the like), the number of CPUs that can be connected to the same bus is about four, for example.

Meanwhile, as in the case where each CPU executes an independent program, even when it is not necessary to keep coherency of the cache memory, the hardware surely performs the snooping process. Thus, due to such wasteful snooping processes, the processing capability of the CPU is lowered and the power consumption in the circuit is increased as a whole.

### SUMMARY OF THE INVENTION

It is an object of the present invention to provide a bus coupled multiprocessor capable of reducing the number of snooping processes of each processor (CPU) constituting the multiprocessor, whereby the performance of the CPU is improved and its power consumption can be reduced.

According to the present invention, a bus coupled multiprocessor includes a plurality of processors connected via the same bus. Each processor has a cache memory. In addition, each processor has a snooping function for the cache memory. In addition, each processor includes a register and a comparing unit. The register stores a bit string including a first bit indicating whether a snooping process is performed or not when each processor is in a predetermined operation mode. The comparing unit compares the first bit stored in the register with mode information indicating the kind of the operation mode outputted when a predetermined processor accesses the bus. Furthermore, the snooping process is selectively performed based on a result of the comparison by the comparing unit.

Therefore, each processor only has to perform the snooping process when a predetermined processor that accessed the bus is in a predetermined operation mode. Thus, a wasteful snooping process can be omitted in each processor. As a result, the processing capability of each processor can be improved and its power consumption can be reduced.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing a constitution of a bus coupled multiprocessor according to the present invention;

FIG. 2 is a view showing an internal constitution of each CPU according to a first embodiment and a constitution in the vicinity of a bus interface in the CPU;

FIG. 3 is a view showing an internal constitution of a cache controller according to the first embodiment and a constitution in the vicinity thereof;

FIG. 4 is a view showing a constitution of a bit string stored in each register in each CPU;

FIG. 5 is a view for explaining the bit constitution of the bit string;

FIG. 6 is a view showing an internal constitution of each CPU according to a second embodiment and a constitution in the vicinity of a bus interface in the CPU;

FIG. 7 is a view showing an internal constitution of a cache controller according to the second embodiment and a constitution in the vicinity thereof;

FIG. 8 is a view showing a constitution of a bit string stored in each register in each CPU;

FIG. 9 is a view for explaining the bit constitution of the bit string; and

FIG. 10 is a view showing one example of grouping of the CPUs according to an operation mode.

### DESCRIPTION OF THE PREFERRED EMBODIMENTS

According to a bus coupled multiprocessor according to the present invention, a plurality of processors are connected to the same bus. Each processor includes a cash memory and each processor has a snooping function for the cache memory. Each embodiment as will be described below is provided based on the bus coupled multiprocessor having the above structure.

The present invention will be described with reference to the drawings showing its embodiments hereinafter. In addition, in the following description, the processor is referred to as the CPU (Central Processing Unit).

### First Embodiment

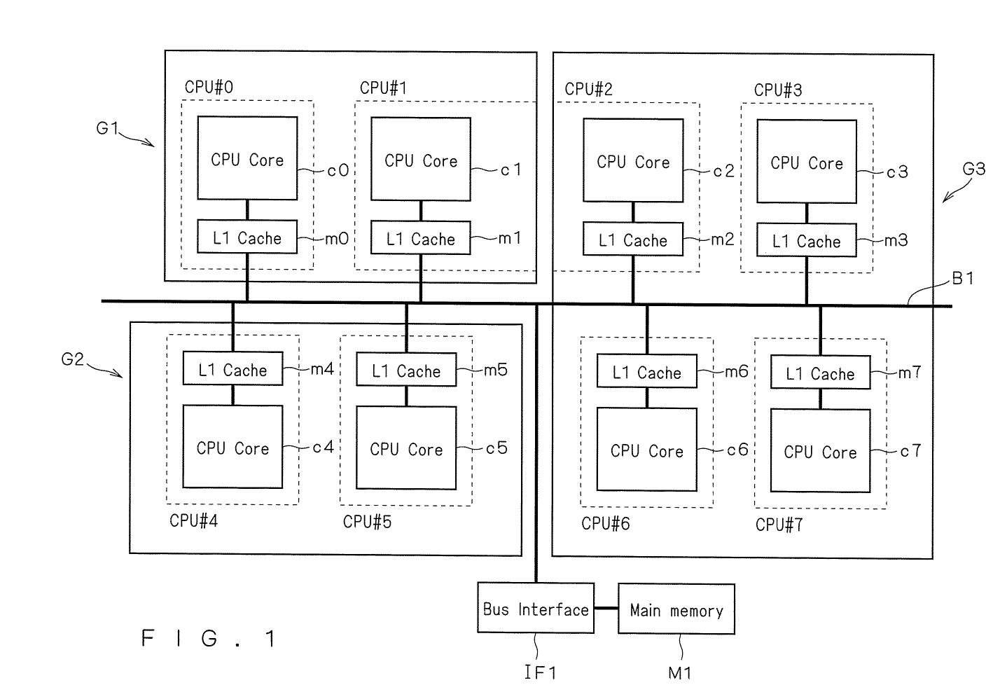

FIG. 1 is a block diagram showing a constitution of a bus coupled multiprocessor according to the present embodiment.

As shown in FIG. 1, each of eight CPUs #0, #1, #2, #3, #4, #5, #6, and #7 is connected to the same bus B1. In addition, a bus interface IF1 and a main memory M1 are connected to the bus B1. Here, it is assumed that all of the CPUs #0 to #7 have the same function and operate as eight symmetric multiprocessors.

Furthermore, as shown in FIG. 1, the processors #0 to #7 are divided into a plurality of groups. For example, the processors #0 to #7 are divided into a plurality of groups based on an operating system (OS) to be executed. That is, each group has an OS different from each other.

According to the example shown in FIG. 1, the CPUs #0 and #1 belong to a group G1. The CPUs #4 and #5 belong to a group G2. The CPUs #2, #3, #6, and #7 belong to a group G3. Here, a first OS is activated in the CPUs #0 and #1 belonging to the group G1. A second OS is activated in the CPUs #4 and #5 belonging to the group G2. A third OS is activated in the CPUs #2, #3, #6 and #7 belonging to the group G3.

Here, a distributed processing mechanism called CPUSET is mounted on a certain OS for multiprocessor recently. The function of the OS is to control the CPU for executing a program at OS level, and the CPUs may be grouped such that the CPUs 0 and 1 belong to an A group and the CPUs 2 and 3 belong to a B group, for example. This technology is based on the fact that performance is higher when a specific CPU continues to execute a predetermined program in executing a plurality of programs. In the case of moving between CPUs (referred to as process migration), since it is necessary to flash the cache or TLB, the cost becomes considerably high. Thus, when a plurality of programs are executed by a plurality of CPUs, a software execution environment in which the CPUs are grouped to execute each program as described above, has been prepared.

Going back, the CPUs #0 to #7 include cache memories m0 to m7, respectively as described above, and have a bus snooping (hereinafter referred to simply as snooping) function for the cache memories m0 to m7.

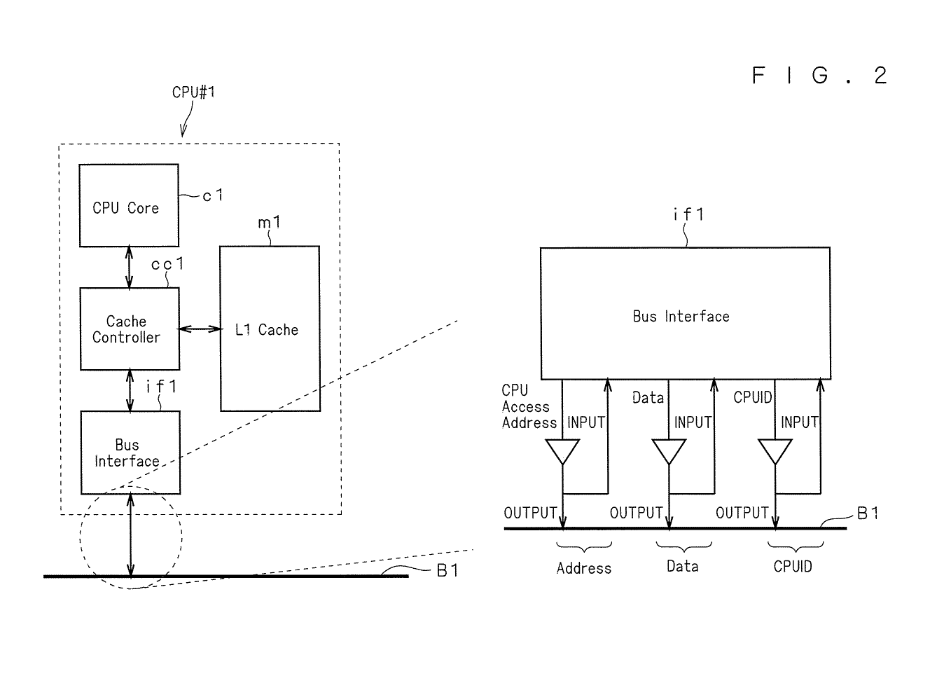

The specific constitution of each of the CPUs #0 to #7 will be described with reference to FIG. 2. Here, FIG. 2 is an enlarged block diagram showing the internal structure of the CPU #1 as one example. The internal structures of the other CPUs #0 and #2 to #7 are the same as that shown in FIG. 2. Therefore, the constitution of the CPU #1 will be only described hereinafter.

As shown in FIG. 2, the CPU #1 includes a CPU core c1, a cache controller cc1, a bus interface if1, and cache memory m1 (circuits other than the CPU cores c0 to c7 and the cache memories m0 to m7 are not shown in FIG. 1 for simplification).

In addition, an enlarged view of the constitution in the vicinity of the bus interface if1 and the bus B1 (area circled with a dotted line) is also shown in FIG. 2.

The bus interface if1 outputs a CPU access address to another CPU, data from itself, and its identification information (CPUID), to the bus B1 at the time of bus accessing. Meanwhile, the bus interface if1 receives a CPU access address from another CPU, data from the other CPU and CPUID from the other CPU transmitted when the other CPU accesses the bus.

Here, the CPUID is identification information unique to each of the CPUs #0 to #7. That is, each of the CPUs #0 to #7 has a different unique CPUID and each of the CPUs #0 to #7 outputs the CPUID to the bus B1 in addition to the CPU access address and the data when it accesses the bus.

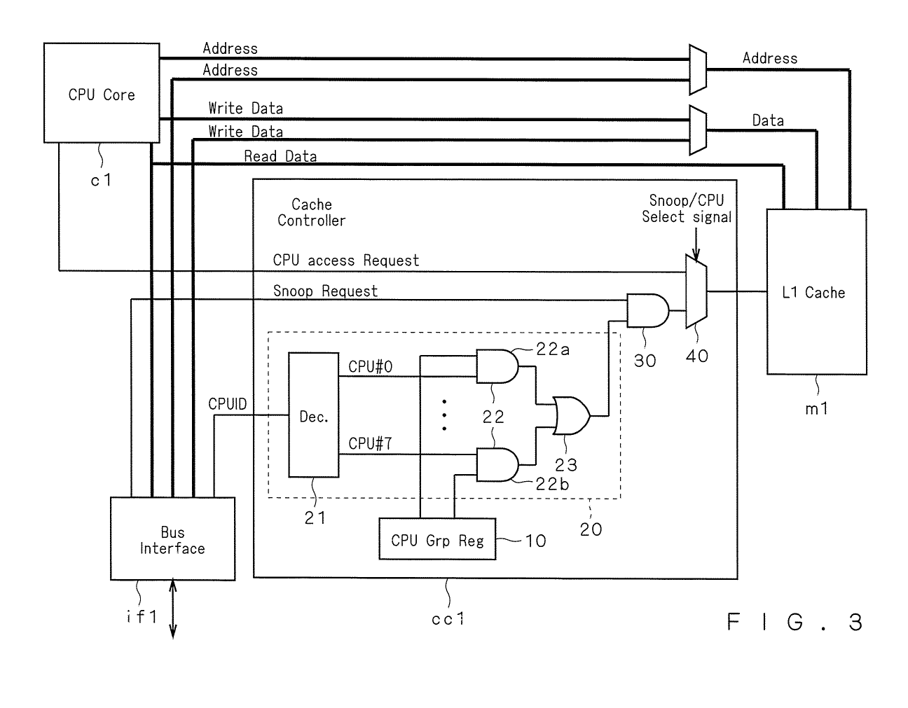

FIG. 3 is a view showing the internal constitution of the cache controller cc1 shown in FIG. 2 in detail. The cache controller shown in FIG. 3 is provided in each of the other CPUs #0 and #2 to #7. Therefore, only the constitution of the CPU #1 will be described below.

As shown in FIG. 3, the CPU #1 (more specifically, the cache controller cc1) includes a register 10 and a comparing unit 20. Here, the cache controller cc1 has the snooping function (mechanism). The cache controller cc1 arbitrates a cache access request of its own CPU #1 and a bus snooping request from the other CPUs #0 and #2 to #7 to access the cache memory m1.

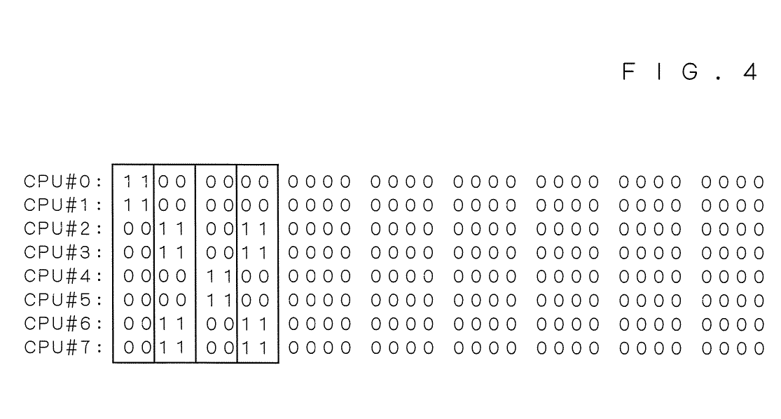

A bit string shown in FIG. 4 is stored in each register 10 arranged in each of the CPUs #0 to #7. Here, the bit string in the top row shown in FIG. 4 is stored in the register 10 in the CPU #0. The bit string in the second row in FIG. 4 is stored in the register 10 in the CPU #1. The bit string in the third row in FIG. 4 is stored in the register 10 in the CPU #2. The bit string in the bottom row in FIG. 4 is stored in the register 10 in the CPU #7.

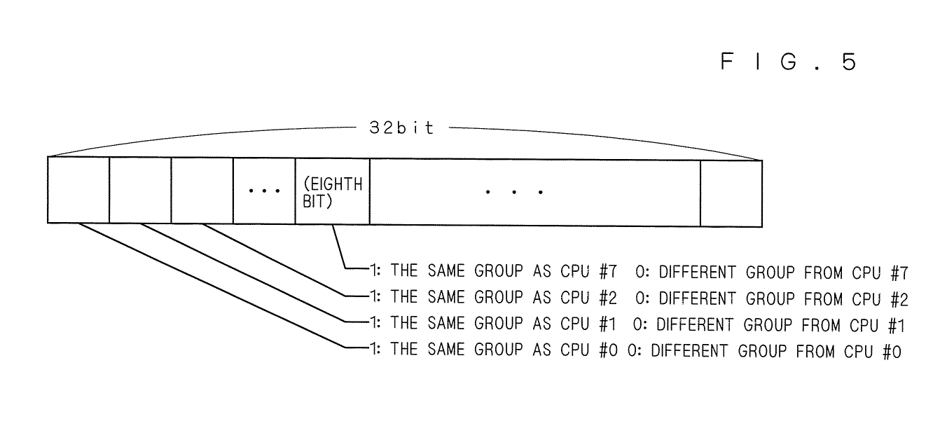

FIG. 5 is a view for explaining the constitution of the bit string stored in the register 10.

As shown in FIG. 5, the bit string including 32 bits is stored in each register 10. The bit string shown in FIG. 5 contains group identifiable bits that can identify the CPU belonging to the group to which its own CPU (that is, the CPU including the register 10 that stores the bit string shown in FIG. 5) belongs, and the CPU not belonging to the group to which its own CPU belongs. As shown in FIG. 1, when there are eight CPUs, first 8 bits in the bit string shown in FIG. 5 correspond to the group identifiable bits.

Referring to FIG. 5, the first bit is a bit for identifying whether its own CPU belongs to the same group as that of the CPU #0, and when its own CPU belongs to the same group as that of the CPU #0, the first bit is “1”, whereas when its own CPU belongs to the group different from that of the CPU #0, the first bit is “0”.

In FIG. 5, the second bit is a bit for identifying whether its own CPU belongs to the same group as that of the CPU #1, and when its own CPU belongs to the same group as that of the CPU #1, the second bit is “1”, whereas when its own CPU belongs to the group different from that of the CPU #1, the second bit is “0”. Similarly, in FIG. 5, the third bit is a bit for identifying whether its own CPU belongs to the same group as that of the CPU #2, and when its own CPU belongs to the same group as that of the CPU #2, the third bit is “1”, whereas when its own CPU belongs to the group different from that of the CPU #2, the third bit is “0”.

Furthermore, in FIG. 5, the eighth bit is a bit for identifying whether its own CPU belongs to the same group as that of the CPU #7, and when its own CPU belongs to the same group as that of the CPU #7, the eighth bit is “1”, whereas when its own CPU belongs to the group different from that of the CPU #7, the eighth bit is “0”.

FIG. 4 is referred in view of the above description.

Focusing on the bit string (in the top row in FIG. 4) stored in the register 10 in the CPU #0 in FIG. 4, since the CPU #0 belongs to the same group as that of the CPU #1 only in the present embodiment, the bit string stored in the register 10 is as shown in the top row in FIG. 4. Here, in FIG. 4, its own CPU #0 belongs to the group G1, “1” is set in the first bit. Therefore, the first bit and the second bit are “1” and the third to eighth bits are “0” in the bit string in the top row in FIG. 4.

Focusing on the bit string (the fifth row in FIG. 4) stored in the register 10 in the CPU #4, since the CPU #4 belongs to the same group as that of the CPU #5 only in the present embodiment, the bit string stored in the register 10 is as shown in the fifth row in FIG. 4. Here, in FIG. 4, its own CPU #4 belongs to the group G2, “1” is set in the fifth bit. Therefore, the fifth and sixth bits are “1” and the bits from the first to the fourth and the seventh and eighth bits are “0” in the bit string in the fifth row in FIG. 4.

Similarly, focusing on the bit string (in the fourth row in FIG. 4) stored in the register 10 in the CPU #3 in FIG. 4, since the CPU #3 belongs to the same group as that of the CPUs #2, #6 and #7 in the present embodiment, the bit string stored in the register 10 is as shown in the fourth row in FIG. 4. Here, in FIG. 4, its own CPU #3 belongs to the group G3, “1” is set in the fourth bit. Therefore, the third, fourth, seventh, eighth bits are “1” and the first, second, fifth and sixth bits are “0” in the bit string in the fourth row in FIG. 4.

The same description can be made for the other bit strings shown in FIG. 4 based on the relation shown in FIG. 1. Thus, the description for the other bit strings shown in FIG. 4 will be omitted.

Next, the comparing unit 20 will be described.

The comparing unit 20 compares the CPUID outputted when a predetermined CPU accesses the bus with the first bit stored in the register 10. The operation of the comparing unit 20 will be described in detail with reference to FIG. 3. Here, it is to be noted that FIG. 3 illustrates the CPU #1 as described above. Therefore, the second bit string in FIG. 4 is stored in the register 10 shown in FIG. 3.

First, description will be made on a case where the CPU #0 outputs a snooping request.

When the snooping request is outputted from the CPU #0 (that is, when the CPU #0 accesses the bus), the bus interface if1 shown in FIG. 3 receives this request and outputs a signal of “1” to one input of an AND circuit 30. When the CPU #0 accesses the bus, the CPUID of the CPU #0 is also transmitted at the same time. Thus, the bus interface if1 shown in FIG. 3 also receives the CPUID of the CPU #0 and transmits the CPUID to a decoder 21 shown in FIG. 3.

The decoder 21 receives the CPUID of the CPU #0, outputs a signal of “1” from an output corresponding to the CPU #0, and outputs a signal of “0” from other outputs corresponding to the other CPUs #1 to #7.

Then, each of the plurality of AND circuits 22 arranged at a latter stage of the decoder 21 performs logical computation between the signal transmitted from one output of the decoder 21 and the first bit contained in the bit string stored in the register 10.

For example, focusing on one AND circuit 22a, one input of the AND circuit 22a is connected to the output of the decoder 21 corresponding to the CPU #0. Therefore, “1” is inputted to the one input of the AND circuit 22a in this case. Meanwhile, the other input of the AND circuit 22a is connected to the first bit of the bit string stored in the register 10. Here, the bit string stored in the register 10 is shown in the second row in FIG. 4. Thus, the AND circuit 22a performs logical computation between the signal of “1” inputted to the one input and the first bit “1” of that bit string. The result of this logical computation is “1”.

Further, focusing on another AND circuit 22b, one input of the AND circuit 22b is connected to the output of the decoder 21 corresponding to the CPU #7. Therefore, “0” is inputted to the one input of the AND circuit 22b in this case. Meanwhile, the other input of the AND circuit 22b is connected to the eighth bit of the bit string stored in the register 10. Here, the bit string stored in the register 10 is shown in the second row in FIG. 4. Thus, the AND circuit 22b performs logical computation between the signal of “0” inputted to the one input and the first bit “0” of that bit string. The result of this logical computation is “0”.

Thus, it is found that when the CPU #0 outputs the snooping request, the signal of “0” is outputted from the another AND circuit (not shown in FIG. 3).

Therefore, the logical computation result of an OR circuit 23 is “1” and the signal of “1” is inputted to the other input of the AND circuit 30. Thus, it can be understood that the logical computation using the plurality of AND circuits 22 and one OR circuit 23 is the comparing operation in the comparing unit 20.

Here, a signal of “1” is outputted from the output of the AND circuit 30 in this case and the signal of “1” is inputted to an input of a selector 40. The selector 40 is so constituted that it gives preference to the snooping request from another CPU over the access request of its own CPU #1.

As described above, since it is determined that the CPU #1 and the CPU #0 belong to the same group G1 from the result of comparison by the comparing unit 20 in this case, the CPU #1 performs the snooping process for its own cache memory m1.

Next, a description will be made of a case where the CPU #7 outputs the snooping request, for example.

When the snooping request is outputted from the CPU #7 (that is, when the CPU #7 accesses the bus), the bus interface if1 shown in FIG. 3 receives this request and outputs the signal of “1” to one input of the AND circuit 30. In addition, when the CPU #7 accesses the bus, the CPUID of the CPU #7 is also transmitted at the same time. Thus, the bus interface if1 shown in FIG. 3 receives the CPUID of the CPU #7 and transmits the CPUID to the decoder 21 shown in FIG. 3.

The decoder 21 receives the CPUID of the CPU #7 and outputs the signal of “1” from the output corresponding to the CPU #7 and outputs the signal of “0” from the outputs corresponding to the other CPUs #0 to #6.

Then, in the plurality of AND circuits 22 arranged at the subsequent stage of the decoder 21, each AND circuit 22 performs logical computation between the signal transmitted from one output of the decoder 21 and the first bit contained in the bit string stored in the register 10.

For example, focusing on one AND circuit 22a, one input of the AND circuit 22a is connected to the output of the decoder 21 corresponding to the CPU #0. Therefore, “0” is inputted to the one input of the AND circuit 22a in this case. Meanwhile, the other input of the AND circuit 22a is connected to the first bit of the bit string stored in the register 10. Here, the bit string stored in the register 10 is shown in the second row in FIG. 4. Thus, the AND circuit 22a performs logical computation between the signal of “0” inputted to the one input and the first bit “1” of that bit string. The result of this logical computation is “0”.

Focusing on another AND circuit 22b, one input of the AND circuit 22b is connected to the output of the decoder 21 corresponding to the CPU #7. Therefore, “1” is inputted to the one input of the AND circuit 22b in this case. Meanwhile, the other input of the AND circuit 22b is connected to the eighth bit of the bit string stored in the register 10. Here, the bit string stored in the register 10 is shown in the second row in FIG. 4. Thus, the AND circuit 22b performs logical computation between the signal of “1” inputted to the one input and the first bit “0” of that bit string. The result of this logical computation is “0”.

Thus, it is found that when the CPU #7 outputs the snooping request, the signal of “0” is outputted from another AND circuit (not shown in FIG. 3).

Therefore, the result of logical computation by OR circuit 23 is “0” and the signal of “0” is inputted to the other input of the AND circuit 30. Thus, it can be grasped that the logical computation using the plurality of AND circuits 22 and one OR circuit 23 is the comparing operation in the comparing unit 20.

In addition, the signal of “0” is outputted from the output of the AND circuit 30 in this case and the signal of “0” is inputted to the input of the selector 40.

As described above, since it is determined that the CPU #1 and the CPU #7 belong to different groups from the result of comparison in the comparing unit 20 in this case, the CPU #1 does not perform the snooping process for its own cache memory m1.

As can be known from the description so far, the CPU to perform the snooping process is determined by the register 10 and the comparing unit 20.

According to the bus coupled multiprocessor regarding the background technique, when another CPU accesses the bus, it cannot be determined whether the accessed data is shared data or not by its own CPU. Therefore, since the hardware of the CPU cannot detect that another OS is activated by another CPU, all of the accesses to the bus from the other CPUs are snooped. That is, each of the CPUs #0 to #7 performs the snooping process without knowing the contents (shared or not) of the software activated in another CPU.

Thus, according to the bus coupled multiprocessor regarding the background technique, the problem is that the processing capability of each CPU is lowered and its power consumption is increased.

Thus, according to the bus coupled multiprocessor regarding to the present embodiment, when one of the CPUs #0 to #7 accesses the bus, it outputs its own CPUID to the bus B1 and the other CPUs #0 to #7 to perform the snooping process observe (receive) the outputted CPUID. Furthermore, each of the CPUs #0 to #7 has a register 10 storing the bit string (especially, the first bit) for identifying whether another CPU belongs to the same group (any of G1 to G3) as its own CPU or not (whether it belongs to the sharing group or not) and only when the CPU determines that the other CPU belonging to the same group accesses, the CPU performs the snooping process.

Therefore, when the CPUs #0 to #7 are grouped as described above (refer to FIG. 1) and each user program is operated in each of the groups G1 to G3, the CPU #0 only has to snoop the bus access of the CPU #1 and when the other CPUs #2 to #7 access the bus, the CPU #0 does not use the cache (does not perform snooping process), for example. Therefore, since the time for accessing the cache memory m0 is increased, the processing capability of the CPU #0 is improved (in addition, it is needless to say that the processing capability of each of the other CPUs #1 to #7 is improved according to the same description).

In addition, as described above, since the CPUs #0 to #7 do not need to access the cache memories m0 to m7, respectively in response to each bus access of all the CPU (that is, since the number of snooping processes is decreased as compared with the conventional case), each of the CPUs #0 to #7 can reduce their power consumption.

In addition, as described above, when the CPUs are grouped based on the OS program, since there is no need to share data between the groups G1 to G3 basically, the bus coupled multiprocessor according to the present embodiment is effective. In addition, when data has to be shared between the different OSs in the above, interruption between the CPUs without using the shared memory may be used.

### Second Embodiment

The bus coupled multiprocessor according to the second embodiment can determine whether each CPU performs the snooping process or not depending on the operation mode of each CPU based on the first embodiment.

Therefore, the bus coupled multiprocessor according to the present embodiment also includes the constitution shown in FIG. 1. That is, each of eight CPUs #0, #1, #2, #3, #4, #5, #6, and #7 is connected to the same bus B1. In addition, a bus interface IF1 and a main memory M1 are connected to the bus B1. Here, it is assumed that all of the CPUs #0 to #7 have the same function and operate as eight symmetric multiprocessors.

Furthermore, as described in the first embodiment, the processors #0 to #7 are divided into a plurality of groups. For example, the processors #0 to #7 are divided into a plurality of groups based on the operating system (OS) to be executed. That is, each group has an OS different from each other.

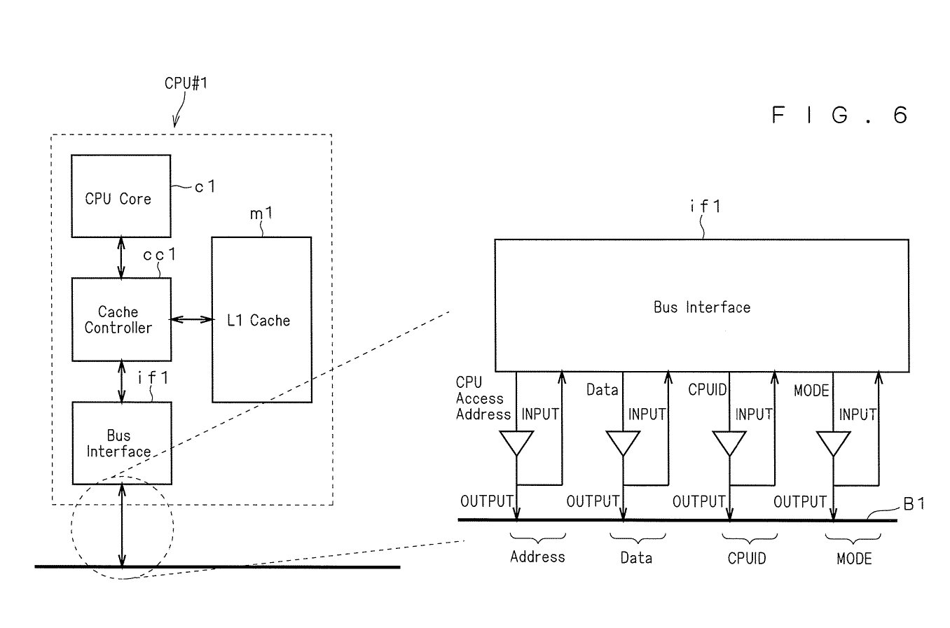

In addition, a more specific constitution of each of the CPUs #0 to #7 is as shown in FIG. 6. Here, the constitution shown in FIG. 6 and the constitution shown in FIG. 2 are the same except for the following point. FIG. 6 is an enlarged block diagram showing the internal structure of the CPU #1 as one example similar to FIG. 2. The internal structure in another CPU is the same as that shown in FIG. 6. Therefore, only the constitution of the CPU #1 will be described hereinafter.

The different point between the constitution shown in FIG. 2 and the constitution shown in FIG. 6 is such that when each bus interface if1 accesses the bus, it transmits to the bus B1 a CPU access address to another CPU, data from itself, and its own CPUID and additionally transmits mode information regarding its own operation mode as shown in the enlarged view of the constitution (area circled with a dotted line) in the vicinity of the bus interface if1 and the bus B1 in FIG. 6.

In addition, each bus interface if1 receives the CPU access address transmitted from another CPU, the data transmitted from the other CPU, and the CPUID transmitted from the other CPU when the other CPU accesses the bus, and additionally receives mode information regarding the operation mode of the other CPU transmitted from the other CPU.

Here, there are a supervisor mode and a user mode as the operation mode of each of the CPUs #0 to #7. In addition, since both the above modes are well-known operation modes, description thereof will be omitted here.

In addition, as shown in FIG. 6, the CPU access address, the data, the CPUID, and the mode information outputted from itself may be returned to that CPU.

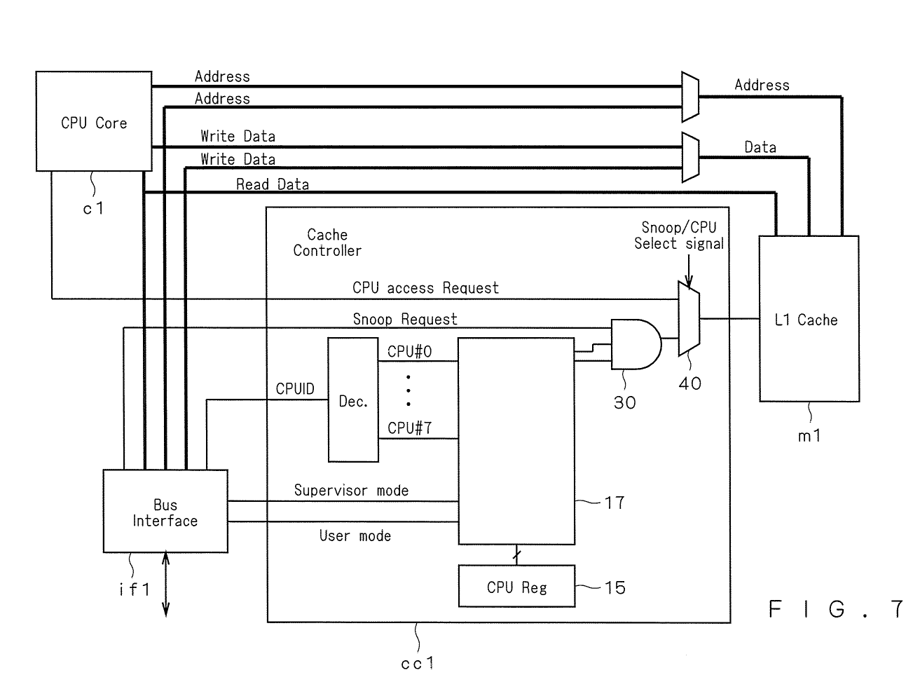

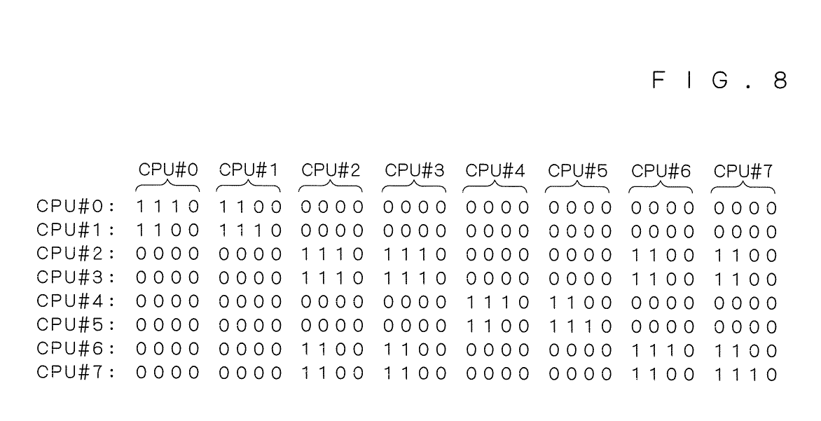

In addition, the constitution according to the present embodiment is different from that according to the first embodiment in the constitution of the comparing unit and the constitution of the bit string stored in the register (refer to FIGS. 7 and 8).

FIG. 7 is a view showing an internal constitution of a cache controller cc1 shown in FIG. 6 in detail. In addition, each of the other CPUs #0, and #2 to #7 also has the cache controller having the constitution shown in FIG. 7.

As shown in FIG. 7, the CPU #1 (more specifically, the cache controller cc1) includes a register 15 and a comparing unit 17. Here, the cache controller cc1 has the snooping function (mechanism). The cache controller cc1 arbitrates the cache access request of its own CPU #1 and a bus snooping request from the other CPUs #0 and #2 to #7 and accesses a cache memory m1.

A bit string including a first bit and a second bit is stored in each register 15 arranged in each of the CPUs #0 to #7. Here, the first bit indicates whether the snooping process is performed or not when the CPUs #0 to #7 are in a predetermined operation mode (supervisor mode and user mode). The second bit is the same as the identifiable bit described in the first embodiment, that is, it can identify another CPU belonging to the group among groups G1 to G3 to which the CPU belongs, and another CPU that does not belong to the group to which the CPU belongs.

For example, a bit string shown in FIG. 8 is stored in each register 15. Here, the bit string shown in the top row in FIG. 8 is stored in the register 15 in the CPU #0. The bit string shown in the second row in FIG. 8 is stored in the register 15 in the CPU #1. The bit string shown in the third row in FIG. 8 is stored in the register 15 in the CPU #2. Furthermore, the bit string shown in the bottom row in FIG. 8 is stored in the register 15 in the CPU #7.

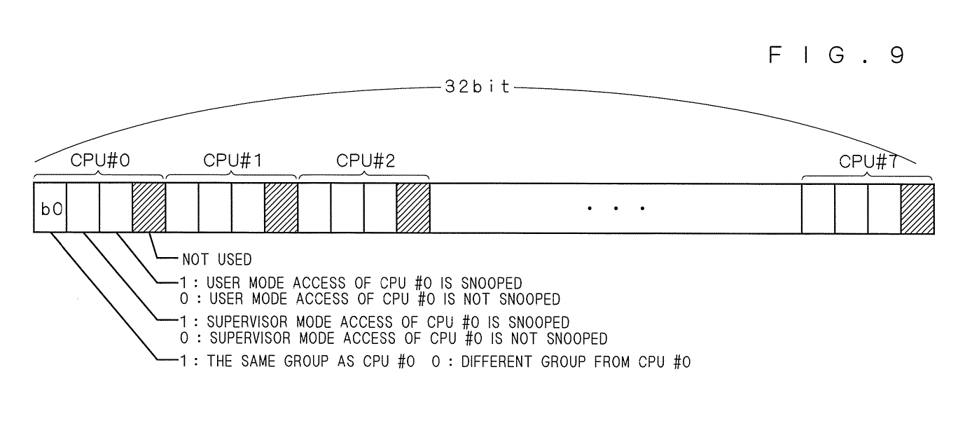

FIG. 9 is a view for explaining the constitution of the bit string stored in the register 15.

As shown in FIG. 9, 32-bit bit string is stored in each register 15. As described above, the bit string shown in FIG. 9 includes the first bit indicating whether the snooping process is to be performed or not when each of the CPUs #0 to #7 is in a predetermined operation mode (supervisor mode and user mode) and the second bit that can identify another CPU belonging to the group among groups G1 to G3 to which the CPU (that is, the CPU including the register 15 storing the bit string shown in FIG. 9) belongs, and another CPU that does not belong to the group to which the CPU belongs.

Referring to FIG. 9, the bits from the first to the fourth bits are defined by the relation with the CPU #0. The bits from the fifth to eighth bits are defined by the relation with the CPU #1. The bits from the ninth to twelfth bits are defined by the relation with the CPU #2. Furthermore, the bits from the 29th to 32nd are defined by the relation with the CPU #7.

More specifically, referring to FIG. 9, the first bit identifies whether the CPU having the register 15 storing the bit string shown in FIG. 9 belongs the same group as that of the CPU #0 or not (when it belongs the same group, the bit is “1” and when it is different, the bit is “0”). When the CPU #0 accesses the bus in the supervisor mode, the second bit identifies whether the CPU having the register 15 storing the bit string shown in FIG. 9 is to perform the snooping process or not (the bit is “1” in the case of snooping process and it is “0” in the case of no snooping process). When the CPU #0 accesses the bus in the user mode, the third bit identifies whether the CPU having the register 15 storing the bit string shown in FIG. 9 is to perform the snooping process or not (the bit is “1” in the case of snooping process and it is “0” in the case of no snooping process). The fourth bit is not used in the example shown in FIG. 9.

Similarly, referring to FIG. 9, the fifth bit identifies whether the CPU having the register 15 storing the bit string shown in FIG. 9 belongs the same group as that of the CPU #1 or not (when it belongs the same group, the bit is “1” and when it is different, the bit is “0”). When the CPU #1 accesses the bus in the supervisor mode, the sixth bit identifies whether the CPU having the register 15 storing the bit string shown in FIG. 9 is to perform the snooping process or not (the bit is “1” in the case of snooping process and it is “0” in the case of no snooping process). When the CPU #1 accesses the bus in the user mode, the seventh bit identifies whether the CPU having the register 15 storing the bit string shown in FIG. 9 is to perform the snooping process or not (the bit is “1” in the case of snooping process and it is “0” in the case of no snooping process). The eighth bit is not used in the example shown in FIG. 9.

The same can be applied to the other bits in FIG. 9. Therefore, referring to FIG. 9, the 29th bit identifies whether the CPU having the register 15 storing the bit string shown in FIG. 9 belongs the same group as that of the CPU #7 or not (when it belongs the same group, the bit is “1” and when it is different, the bit is “0”). When the CPU #7 accesses the bus in the supervisor mode, the 30th bit identifies whether the CPU having the register 15 storing the bit string shown in FIG. 9 is to perform the snooping process or not (the bit is “1” in the case of snooping process and it is “0” in the case of no snooping process). When the CPU #7 accesses the bus in the user mode, the 31th bit identifies whether the CPU having the register 15 storing the bit string shown in FIG. 9 is to perform the snooping process or not (the bit is “1” in the case of snooping process and it is “0” in the case of no snooping process). The 32th bit is not used.

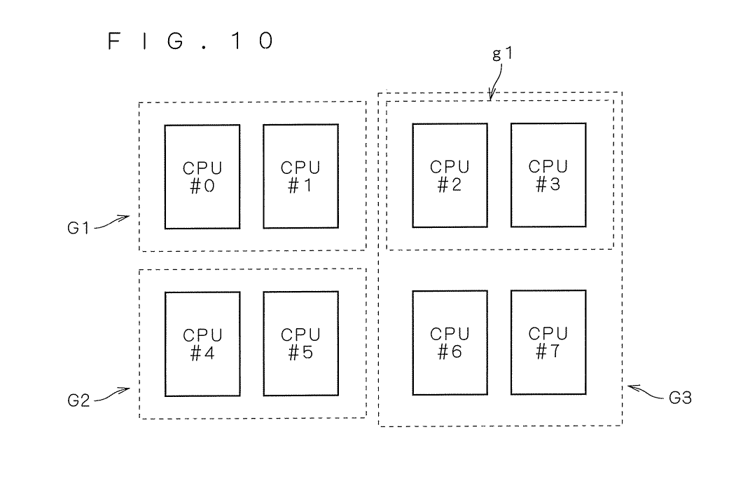

Here, referring to FIG. 10, when one CPU accesses the other CPU via the bus in the supervisor mode between the CPUs #0 and #1 in the group G1, both the CPUs #0 and #1 perform the snooping process in the present embodiment. In other words, even when each of the CPUs #0 and #1 is accessed from the other CPUs #2 to #7 via the bus in the supervisor mode, the snooping process is not performed. When the CPU #0 is accessed from the other CPUs #1 to #7 via the bus in the user mode, the snooping process is not performed. When the CPU #1 is accessed from the other CPUs #0 and #2 to #7 via the bus in the user mode, the snooping process is not performed.

When one CPU accesses the other CPU via the bus in the supervisor mode between the CPUs #4 and #5 in the group G2, both the CPUs #4 and #5 perform the snooping process in the present embodiment. In other words, even when each of the CPUs #4 and #5 is accessed from the other CPUs #0 to #3 and #6 and #7 via the bus in the supervisor mode, the snooping process is not performed. When the CPU #4 is accessed from the other CPUs #0 to #3 and #5 to #7 via the bus in the user mode, the snooping process is not performed. In addition, when the CPU #5 is accessed from the other CPUs #0 to #4 and #6 and #7 via the bus in the user mode, the snooping process is not performed.

When one CPU accesses the other CPU via the bus in the supervisor mode among the CPUs #2, #3, #6 and #7 in the group G3, the CPUs #2, #3, #6 and #7 perform the snooping process. In other words, even when each of the CPUs #2, #3, #6 and #7 is accessed from the other CPUs #0, #1, #4 and #5 via the bus in the supervisor mode, the snooping process is not performed. When one CPU accesses the other CPU via the bus between the CPUs #2 and #3 in the user mode, both the CPUs #2 and #3 perform snooping process. In other words, even when each of the CPUs #2 and #3 is accessed from the other CPUs #0, #1 and #4 to #7 via the bus in the user mode, the snooping process is not performed. When the CPU #6 is accessed from the other CPUs #0 to #5 and #7 via the bus in the user mode, the snooping process is not performed. Further, when the CPU #7 is accessed from the other CPUs #0 to #6 via the bus in the user mode, the snooping process is not performed.

That is, when one CPU is accessed from another CPU belonging to the same group via the bus in the supervisor mode, the snooping process is performed. Even when one CPU is accessed from another CPU via the bus in the user mode, the snooping process is not performed. However, when one CPU is accessed from another CPU via the bus in the user mode in a group g1 (that is, between the CPUs #2 and #3), in FIG. 10 the snooping process is performed.

In view of the above, the bit string stored in each register 15 is as shown in FIG. 8.

For example, according to the case of the present embodiment, since the CPU #1 belongs to the same group as that of the CPU #0 only, as shown in the second row in FIG. 8, the first bit is “1”. Since the CPU #1 performs the snooping process when the CPU #0 accesses the bus in the supervisor mode, the second bit is “1”. Since the CPU #1 does not perform the snooping process even when the CPU #0 accesses the bus in the user mode, the third bit is “0”. Since the CPU #1 belongs to the same group as the CPU #1 as a matter of course, it performs the snooping process when the CPU #1 itself accesses the bus in the supervisor mode, and when the CPU #1 itself accesses the bus in the user mode, so that the bits from the fifth to seventh bits are “1” as shown in the second row in FIG. 8. In addition, since the CPU #1 belongs to the group different from those of the CPUs #2 to #7, it does not perform the snooping process even when the CPUs #2 to #7 access the bus in the supervisor mode or the CPUs #2 to #7 access the bus in the user mode, so that the bits from the 9th bit to 32th bit are all “0” as shown in the second row in FIG. 8.

Similarly, according to the present embodiment, since the CPU #2 belongs to the same group as that of the CPUs #3, #6 and #7, as shown in the third row in FIG. 8, the 9th, 13th, 25th, and 29th bits are “1”. Since the CPU #2 performs the snooping process when the CPUs #2, #3, #6, and #7 access the bus in the supervisor mode, the 10th, 14th, 26th, and 30th bits are “1”. Since the CPU #2 performs the snooping process when the CPUs #2 and #3 access the bus in the user mode, the 11th and 15th bits are “1”. Since the CPU #2 belongs to the group different from those of the CPUs #0, #1, #4 and #5, it does not perform the snooping process even when the CPUs #0, #1, and #4 to #7 access the bus in the supervisor mode or even when the CPUs #0, #1, and #4 to #7 access the bus in the user mode, so that the other bits are all “0” as shown in the third row in FIG. 8.

The same description can be applied to the other bit strings shown in FIG. 8. Thus, the description of the other bit strings shown in FIG. 8 will be omitted.

Next, the comparing unit 17 will be described.

The comparing unit 17 according to the present embodiment compares mode information indicating the kind of the operation mode outputted when a predetermined CPU (#0 to #7) accesses the bus, with the first bit stored in the register 15 (referred to as the first comparing process). Furthermore, the comparing unit 17 compares identification information (CPUID) given uniquely to each of the CPUs #0 to #7 outputted when a predetermined CPU (#0 to #7) accesses the bus with the second bit stored in the register 15 (referred to as the second comparing process).

As a result of the first comparing process, when the CPU #1 that received the mode information and has the constitution shown in FIG. 7 (that is, the comparing unit 17 in the CPU #1) determines to perform the snooping process when a predetermined CPU (#0 to #7) is in the operation mode whose kind is designated by the mode signal, the comparing unit 17 outputs a signal of “1” to an AND circuit 30 at the subsequent stage.

Furthermore, as a result of the second comparing process, when the CPU #1 that received the CPUID determines that it belongs to the same group as that of the predetermined CPU (#0 to #7), the comparing unit 17 outputs the signal of “1” separately from the above to the AND circuit 30 at the subsequent stage.

For example, when the CPU #0 accesses the bus in the supervisor mode, the CPU #0 outputs the CPUID of the CPU #0 and the mode information of the supervisor mode to the bus B1. In the CPU #1 that received the CPUID and the mode information, the comparing unit 17 compares the CPUID and the mode information with the bit string in the resister 15 in the CPU #1.

Here, as described above, when the CPU #0 accesses the bus in the supervisor mode, since the comparing unit 17 of the CPU #1 determines to perform the snooping process, the comparing unit 17 outputs a signal of “1” to the AND circuit 30 as a result of the first comparing process.

Since the CPUs #0 and #1 belong to the same group G1 as described above, the comparing unit 17 outputs a signal of “1” separately, to the AND circuit 30 as a result of the second comparing process.

When another snooping request is transmitted, a snooping request signal of “1” is inputted to the AND circuit 30. Therefore, in this case, since the signal of “1” is inputted to each of three inputs of the AND circuit 30, a signal of “1” is outputted from the AND circuit 30 to the selector 40. Here, the selector 40 is so constituted that it gives preference to the snooping request from the other CPU over the access request of its own CPU #1.

As described above, in this case, since the CPU #1 determines that the CPUs #1 and #0 belong to the same group G1 and determines to perform the snooping process when the CPU #0 is in the supervisor mode as the result of the first and second comparing processes, the CPU #1 performs the snooping process. That is, the CPU #1 performs the snooping process for its own cache memory m1.

In addition, for example, when the CPU #0 accesses the bus in the user mode, the CPU #0 outputs the CPUID of the CPU #0 and the mode information of the user mode to the bus B1. The CPU #1 receives the CPUID and the mode information and its comparing unit 17 compares the CPUID and the mode information with the bit string stored in the register 15 in its own CPU #1.

Here, as described above, when the CPU #0 accesses the bus in the user mode, since the comparing unit 17 of the CPU #1 determines not to perform the snooping process, the comparing unit 17 outputs a signal of “0” to the AND circuit 30 as a result of the first comparing process.

In addition, since the CPUs #0 and #1 belong to the same group G1, the comparing unit 17 outputs the signal of “1” separately to the AND circuit 30 as a result of the second comparing process.

In addition, when another snooping request is transmitted, the snooping request signal of “1” is inputted to the AND circuit 30. Therefore, in this case, since the signal of “1” is inputted to two inputs of the AND circuit 30 and the signal of “0” is inputted to the other one input thereof, a signal of “0” is outputted from the AND circuit 30 to the selector 40.

As described above, in this case, since the CPU #1 determines that the CPUs #1 and #0 belong to the same group G1 and determines not to perform the snooping process when the CPU #0 is in the user mode as the result of the first and second comparing processes, the CPU #1 does not perform the snooping process. That is, the CPU #1 does not perform the snooping process for its own cache memory m1.

In addition, for example, when the CPU #5 accesses the bus in the supervisor mode or the user mode, the CPU #5 outputs the CPUID of the CPU #5 and the mode information of the supervisor mode or the user mode to the bus B1. The CPU #1 receives the CPUID and the mode information and its comparing unit 17 compares the CPUID and the mode information with the bit string stored in the register 15 in it own CPU #1.

Here, as described above, when the CPU #5 accesses the bus in the supervisor mode or the user mode, since the comparing unit 17 of the CPU #1 determines not to perform the snooping process, the comparing unit 17 outputs the signal of “0” to the AND circuit 30 as a result of the first comparing process.

Since the CPUs #5 and #1 belong to different groups as described above, the comparing unit 17 outputs the signal of “0” separately to the AND circuit 30 as a result of the second comparing process.

When another snooping request is transmitted, the snooping request signal of “1” is inputted to the AND circuit 30. Therefore, in this case, since the signal of “0” is inputted to the two inputs of the AND circuit 30 and the signal of “1” is inputted to the other one input thereof, the signal of “0” is outputted from the AND circuit 30 to the selector 40.

As described above, in this case, since the CPU #1 determines that the CPUs #1 and #5 belong to different groups and determines not to perform the snooping process when the CPU #5 is in the supervisor mode or in the user mode as the result of the first and second comparing processes, the CPU #1 does not perform the snooping process. That is, the CPU #1 does not perform the snooping process for its own cache memory m1.

In order to prevent the error in the process of the comparing unit 17 and the operation for determining whether the snooping process is performed or not, another case is used for description.

For example, when the CPU #7 accesses the bus in the supervisor mode, the CPU #7 outputs the CPUID of the CPU #7 and the mode information of the supervisor mode to the bus B1. The CPU #3 receives the CPUID and the mode information and its comparing unit 17 compares the CPUID and the mode information with the bit string stored in the register 15 in its own CPU #3.

Here, as described above, when the CPU #7 accesses the bus in the supervisor mode, since the comparing unit 17 of the CPU #3 determines to perform the snooping process, the comparing unit 17 outputs a signal of “1” to the AND circuit 30 as a result of the first comparing process.

Since the CPUs #7 and #3 belong to the same group G3 as described above, the comparing unit 17 outputs a signal of “1” separately to the AND circuit 30 as a result of the second comparing process.

When another snooping request is transmitted, the snooping request signal of “1” is inputted to the AND circuit 30. Therefore, in this case, since the signal of “1” is inputted to three inputs of the AND circuit 30, the signal of “1” is outputted from the AND circuit 30 to the selector 40.

As described above, in this case, since the CPU #3 determines that the CPUs #3 and #7 belong to the same group G3 and determines to perform the snooping process when the CPU #7 is in the supervisor mode as the result of the first and second comparing processes, the CPU #3 performs the snooping process. That is, the CPU #3 performs the snooping process for its own cache memory m3.

Further, for example, when the CPU #7 accesses the bus in the user mode, the CPU #7 outputs the CPUID of the CPU #7 and the mode information of the user mode to the bus B1. The CPU #3 receives the CPUID and the mode information and its comparing unit 17 compares the CPUID and the mode information with the bit string stored in the register 15 in its own CPU #3.

Here, as described above, when the CPU #7 accesses the bus in the user mode, since the comparing unit 17 of the CPU #3 determines not to perform the snooping process, the comparing unit 17 outputs the signal of “0” to the AND circuit 30 as a result of the first comparing process.

In addition, as described above, since the CPUs #3 and #7 belong to the same group G3, the comparing unit 17 outputs the signal of “1” separately to the AND circuit 30 as a result of the second comparing process.

When another snooping request is transmitted, the snooping request signal of “1” is inputted to the AND circuit 30. Therefore, in this case, since the signal of “1” is inputted to the two inputs of the AND circuit 30 and the signal of “0” is inputted to the other one input thereof, the signal of “0” is outputted from the AND circuit 30 to the selector 40.

As described above, in this case, since the CPU #3 determines that the CPUs #3 and #7 belong to the same group G3 and determines not to perform the snooping process when the CPU #7 is in the user mode as the result of the first and second comparing processes, the CPU #3 does not perform the snooping process. That is, the CPU #3 does not perform the snooping process for its own cache memory m3.

In addition, for example, when the CPU #2 accesses the bus in the user mode, the CPU #2 outputs the CPUID of the CPU #2 and the mode information of the user mode to the bus B1. The CPU #3 receives the CPUID and the mode information and its comparing unit 17 compares the CPUID and the mode information with the bit string stored in the register 15 in its own CPU #3.

Here, as described above, when the CPU #2 accesses the bus in the user mode, since the comparing unit 17 of the CPU #3 determines to perform the snooping process, the comparing unit 17 outputs a signal of “1” to the AND circuit 30 as a result of the first comparing process.

Since the CPUs #2 and #3 belong to the same group G3 as described above, the comparing unit 17 outputs a signal of “1” separately to the AND circuit 30 as a result of the second comparing process.

When another snooping request is transmitted, the snooping request signal of “1” is inputted to the AND circuit 30. Therefore, in this case, since the signal of “1” is inputted to the three inputs of the AND circuit 30, a signal of “1” is outputted from the AND circuit 30 to the selector 40.

As described above, in this case, since the CPU #3 determines that the CPUs #3 and #2 belong to the same group and determines to perform the snooping process when the CPU #2 is in the user mode as the result of the first and second comparing processes, the CPU #3 performs the snooping process. That is, the CPU #3 performs the snooping process for its own cache memory m3.

Here, the above determining operation in another case can be easily understood from the above description. Therefore, the description here will be omitted. Thus, the comparing unit 17 capable of performing the above first and second comparing operations and the above determining operation after each of the comparing operations includes a combination of the plurality of AND circuits and the plurality of OR circuits.

As can be seen from the above description so far, according to the present embodiment, the CPU that received the CPUID and the mode information identifies the CPU to be snooped based on the register 15 and the comparing unit 17 (that is, based on the CPUID and the mode information outputted from each of the CPUs #0 to #7 at the time of accessing the bus).

As described above, in the bus coupled multiprocessor according to the present embodiment, each of the CPUs #0 to #7 includes the register 15 storing the bit string (refer to FIG. 8) containing the first bit, and the comparing unit 17 for performing the first comparing process. Thus, when a predetermined CPU accesses the bus in a predetermined operation mode, each of the CPUs #0 to #7 determines whether the snooping process is performed or not when the predetermined CPU is in the operation mode designated by the mode signal transmitted at the time of the bus accessing as a result of the first comparing process in the comparing unit 17. When the CPU determines to perform the snooping process, it performs the snooping process.

In other words, when each of the CPUs #0 to #7 accesses the bus in a predetermined operation mode, each of the CPUs #0 to #7 outputs the mode information. Thus, each of the CPUs #0 to #7 observes (receives) the mode information, and the comparing unit 17 performs the first comparing process using the first bit stored in its own register 15 and the mode information. Then, each of the CPUs #0 to #7 determines whether the snooping process is performed or not based on the result of the first comparing process. Each of the CPUs #0 to #7 does not access the cache for the bus access that is determined as unshared data.

According to the above constitution, since each of the CPUs #0 to #7 only has to perform the snooping process when the CPU that accessed the bus is in the predetermined operation mode, the snooping process is not wasted in each of the CPUs #0 to #7. As a result, the processing capability of each of the CPUs #0 to #7 can be improved and its power consumption can be reduced.

For example, although it is different from the above case, a case where eight CPUs #0 to #7 operate one OS and each of the eight CPUs #0 to #7 executes a different user program may be assumed. Here, the case may be such that some CPUs of the CPUs #0 to #7 execute one user program cooperatively. For example, the case may be such that the CPUs #0 to #5 execute user programs different from each other and the CPUs #6 and #7 execute another user program cooperatively.

In the above case, a first bit that can determine that the snooping process is performed when each of the CPUs #0 to #7 accesses the bus in the supervisor mode is stored in each resister 15 in each of the CPUs #0 to #7. Furthermore, when each of the eight CPUs #0 to #7 executes a user program different from each other, a first bit that can determine that the snooping process is not performed when each of the CPUs #0 to #7 accesses the bus in the user mode is stored in the resister 15.

Since the comparing unit 17 performs the first comparing process in the above situation, each of the CPUs #0 to #7 constituting the bus coupled multiprocessor according to the present embodiment can operate one OS program normally. In addition, when each of the CPUs #0 to #7 accesses the bus in the user mode in which it is not necessary to share the data, since each of the CPUs #0 to #7 does not perform the snooping process, the processing capability of the CPUs #0 to #7 is improved and the power consumption can be reduced.

However, according to the actual bus coupled multiprocessor, as shown in FIG. 1, the CPUs #0 to #7 are grouped into a plurality of groups G1 to G3 based on the OS executed by them in some cases. A different user program is operated in each group of groups G1 to G3 in some cases.

In this case, as described above, the bit string including the first bit and the second bit as shown in FIG. 8 is stored in each register 15 in each of the CPUs #0 to #7, and the comparing unit 17 performs the above-described first and second comparing processes.

In other words, when each of the CPUs #0 to #7 accesses the bus in the predetermined operation mode, each of the CPUs #0 to #7 outputs the mode information and the CPUID. Thus, each of the CPUs #0 to #7 observes (receives) the mode information and the CPUID, and the comparing unit 17 performs the first comparing process using the first bit stored in its own register 15 and the mode information, and the comparing process using the second bit and the CPUID. Thus, each of the CPUs #0 to #7 determines whether the snooping process is performed or not based on the result of the first comparing process.

That is, as the result of the first and second comparing processes in the comparing unit 17, when each of the CPUs #0 to #7 determines that the CPU that received the CPUID and the mode information and the CPU that transmitted the CPUID and the mode information belong to the same group (G1 to G3) and that the snooping process is performed when the CPU is in the operation mode designated by the transmitted mode signal, the CPU that received the CPUID and the mode information performs the snooping process.

Thus, the OS program can be normally operated in each of the groups G1 to G3. Here, as shown in FIG. 10, in the case where one user mode is activated by the CPUs #2 and #3 belonging to the group G3, by storing the first bits in the third and fourth rows in FIG. 8 in the resisters 15 of the CPUs #2 and #3, the one user program can be activated normally in the CPUs #2 and #3.

In addition, even when the predetermined CPU accesses the bus in the supervisor mode or the user mode, the CPU belonging to the group (G1 to G3) different from that of the predetermined CPU does not perform the snooping process. Thus, the processing capability of each of the CPUs #0 to #7 can be improved and the power consumption can be reduced.

Furthermore, when the CPU #2 accesses the bus in the user mode in the above example, the CPU #3 belonging to the same group g2 as that of the CPU #2 performs the snooping process but the CPUs #6 and #7 belonging to the same group G3 as that of the CPU #2 does not perform the snooping process. Thus, in the above example, the processing capability of the CPUs #6 and #7 can be improved and their power consumption can be reduced.

In addition, in the case of the first embodiment, when each of the CPUs #0 to #7 activates each user program in each of the groups G1 to G3, every time the CPU belonging to the same group accesses the bus, another CPU belonging to the same group performs the snooping process. However, in the case where the OS program is activated in each group, it is necessary to share the data between the CPUs belonging to the same group, but in the case where each CPU belonging to the same group activates each user program, another CPU belonging to the same group does not need to perform the snooping process each time the CPU belonging to the same group accesses the bus in many cases.

Therefore, as described above, when another CPU belonging to the same group performs the snooping process every time the CPU belonging to the same group accesses the bus in the user mode, processing capability of each CPU is lowered and its power consumption is increased.

In contrast, according to the bus coupled multiprocessor regarding the present embodiment, the problem with the first embodiment can be solved as described above.

In addition, each bit string shown in FIG. 8 is only an example and it can be varied in accordance with the specifications of the bus coupled multiprocessor. For example, a second CPU may perform the snooping process only when a first CPU accesses the bus in the supervisor mode, or the second CPU may perform the snooping process only when the first CPU accesses the bus in the user mode. Furthermore, the second CPU may perform the snooping process when the first CPU accesses the bus in the supervisor mode and in the user mode.

Moreover, the groups G1 to G3 of the CPUs #0 to #7 may be changed according to the specifications of the bus coupled multiprocessor.

While the invention has been shown and described in detail, the foregoing description is in all aspects illustrative and not restrictive. It is therefore understood that numerous modifications and variations can be devised without departing from the scope of the invention.

What is claimed is:

1. A bus coupled multiprocessor in which a plurality of processors each having a cache memory and having a snooping function for said cache memory are connected through the same bus, wherein
each processor comprises:
a register for storing a bit string including a first bit indicating whether a snooping process is performed or not when each said processor is in a predetermined operation mode; and
a comparing unit for comparing said first bit stored in said register with mode information indicating the kind of said operation mode outputted when predetermined said processor accesses the bus, and
each of said processor selectively performs said snooping process based on the result of comparison in said comparing unit.

2. The bus coupled multiprocessor according to claim 1, wherein said operation mode includes a supervisor mode and a user mode.

3. The bus coupled multiprocessor according to claim 2, wherein
said processors are grouped into a plurality of groups based on an operating system (OS) to be executed,
the bit string stored in said register contains a second bit capable of identifying said processor belonging to the same group as its own group and said processor not belonging to the same group as its own group, and
said comparing unit compares said second bit stored in said register with identification information uniquely given to each of said processors, outputted when said predetermined processor accesses the bus.
